(19) United States
(12) Patent Application Publication
(10) Pub. No.: US 2010/0250946 A1
(43) Pub. Date: Sep. 30, 2010

(54) AD HOC DISTRIBUTION

(76) Inventors: Michael D. Korte, Cupertino, CA (US); Lisa M. Tyerman, Menlo Park, CA (US); Norman Norris, Campbell, CA (US); Nicole Dodge Naidu, San Jose, CA (US); Eric Kelley, Madison, WI (US); Nitin Mishra, San Francisco, CA (US)

Correspondence Address: APPLE INC./BSTZ;BLAKELY SOKOLOFF TAYLOR & ZAFMAN LLP, 1279 OAKMEAD PARKWAY, SUITE 300, SUNNYVALE, CA, 94085-4040, US

(21) Appl. No.: 12/428,879

(22) Filed: Apr. 23, 2009

Related U.S. Application Data
(60) Provisional application No. 61/165,334, filed on Mar. 31, 2009.

(51) Int. Cl. H04L 9/32

(52) U.S. Cl. 713/175; 726/6

(57) ABSTRACT

Systems and methods for developing an application for a data processing device using a portal, such as a world wide web portal. In one exemplary method, an application signing certificate is generated using the portal, and the portal designates the data processing device using a unique device identifier. A unique application identifier for the application is created using the portal. An application provisioning file is created using the portal. The application provisioning profile comprises the application signing certificate, the unique application identifier, and the unique device identifier.

This application claims priority to co-pending U.S. Provisional Application No. 61/165,334 filed on Mar. 31, 2009, which provisional application is incorporated herein by reference in its entirety.

### BACKGROUND

Embodiments of the invention relate to applications for execution on data processing systems, and more particularly distributing applications to data processing systems. Certain embodiments relate to systems to help software developers who are creating software.

### SUMMARY OF THE INVENTION

Systems and methods for developing an application for a data processing device using a portal, such as a world wide web portal. In one exemplary method, an application signing certificate is generated using the portal, and the portal designates the data processing device using a unique device identifier. A unique application identifier for the application is created using the portal. An application provisioning file is created using the portal. The application provisioning profile comprises the application signing certificate, the unique application identifier, and the unique device identifier. The provisioning profile may be signed by a trusted certificate.

### BRIEF DESCRIPTION OF THE DRAWINGS

The present invention is illustrated by way of example and not limitation in the figures of the accompanying drawings in which like references indicate similar elements.

FIG. 1A is an example graphical user interface of an application development portal;

FIG. 1B is a flow diagram illustrating a method of distributing an application to be performed by a data processing system according to an embodiment of the invention;

FIG. 2 is a flow diagram illustrating an ad hoc method of distributing an application to be performed by a data processing system according to an embodiment of the invention;

FIG. 3 is a flow diagram illustrating an enterprise method of distributing an application to be performed by a data processing system according to an embodiment of the invention;

FIG. 4 is a flow diagram illustrating a method of adding a team member to be performed by a data processing system according to an embodiment of the invention;

FIG. 5 is a flow diagram illustrating method of generating an application signing certificate to be performed by a data processing system according to an embodiment of the invention;

FIG. 6 is a flow diagram illustrating method of associating a device with a team to be performed by a data processing system according to an embodiment of the invention;

FIG. 7 is a flow diagram illustrating method of generating an application identifier to be performed by a data processing system according to an embodiment of the invention;

FIG. 8 is a flow diagram illustrating method of generating an ad hoc distribution provisioning profile to be performed by a data processing system according to an embodiment of the invention;

FIG. 9 is a diagram of a data processing system;

FIG. 10 is a diagram of a device;

FIG. 11 is an example graphical user interface displaying team member invitations;

FIGS. 12A-12C are example graphical user interfaces displaying certificate creation;

FIG. 13 is an example graphical user interface displaying device addition;

FIG. 14 is an example graphical user interface displaying application identifier creation;

FIGS. 15-17 are example graphical user interfaces displaying provisioning profile creation; and

FIG. 18 is a diagram illustrating data flow during application distribution according to an embodiment of the invention.

FIG. 19A-19B are diagrams illustrating application distribution and organizations.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2008.

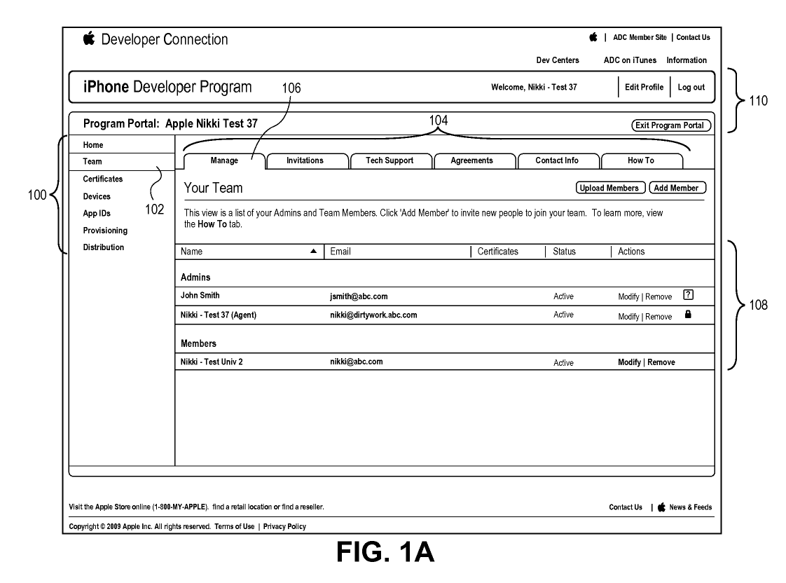

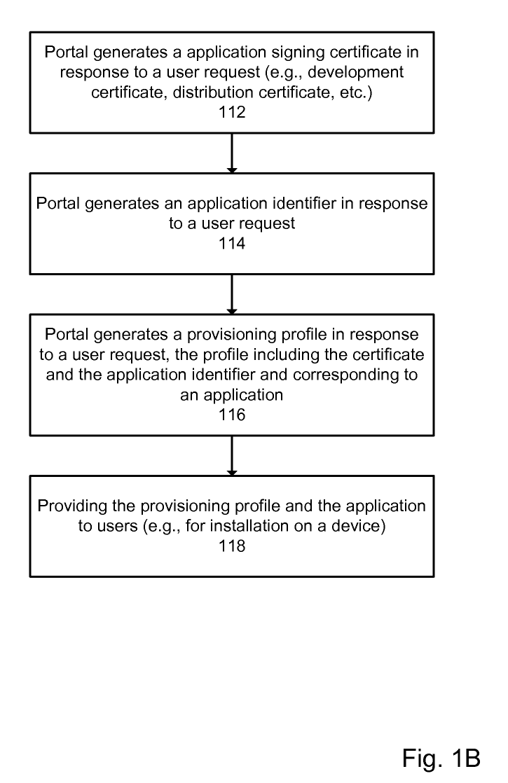

FIG. 1A is an example graphical user interface of an application development portal. An application development portal provides a way for software developers to create and distribute one or more versions of software to users. The portal can be provided by a server, such as a web server on the internet which can be accessible to both one or more software developers. The portal can provide a way to digitally sign applications with a certificate and to provide unique device identifiers for each device which can receive and execute applications developed through or distributed with the portal. The same portal (e.g., the same domain or URL) can provide all of these features in one embodiment. In one embodiment, the portal may be provided by a distributor of software for a device, such as a consumer electronic device. The device may be a general purpose desktop computer or a smartphone or other data processing devices. The portal may be controlled by an entity associated with the software (e.g., a developer, distributor, agents of the developer, etc.), an entity associated with the device (e.g., designer, manufacturer, distributor, retailer, etc.) or a different entity. Categories 100 lists various tasks associated with software application development and distribution. Highlighted category 102 indicates that “Team” is the active category. Tabs 104 list various aspects of the “Team” category. Boldface tab 106 indicates that the current aspect of “Team” is “Manage.” Display region 108 provides access to the various graphical user interface items associated with managing teams. Display region 110 illustrates various general-purpose functions, such as logging out of the portal and managing the current user's portal account. Efficiency of application development and distribution is streamlined by placing many of the various categories and aspects of development and distribution in a single portal which may be a web site specified by one or more URLs.

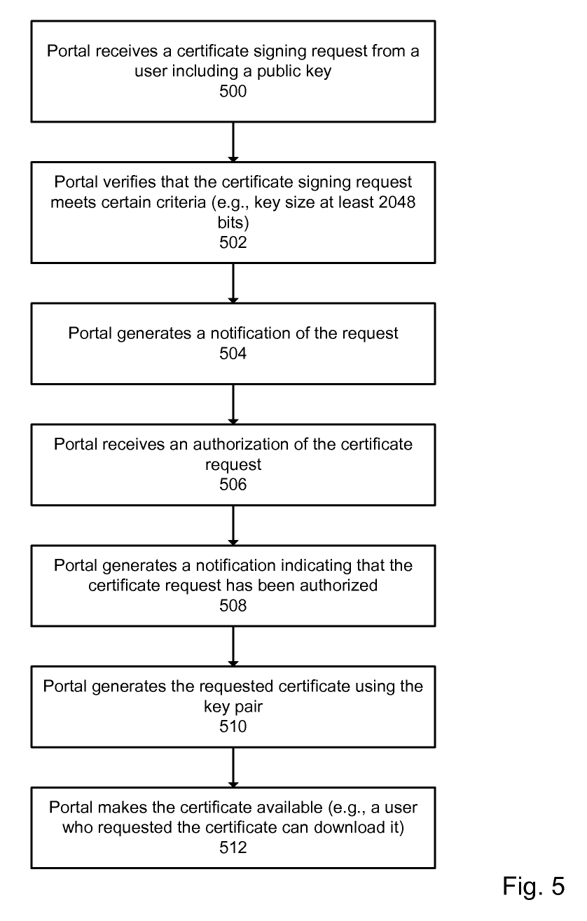

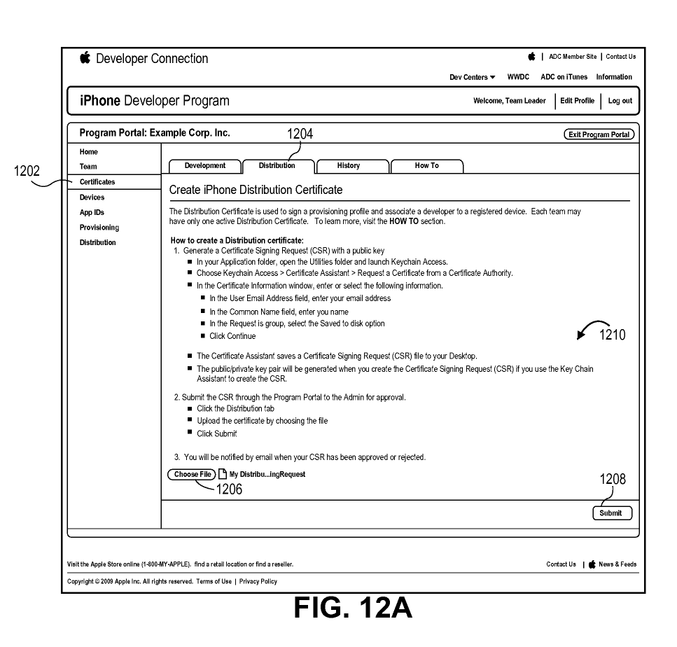

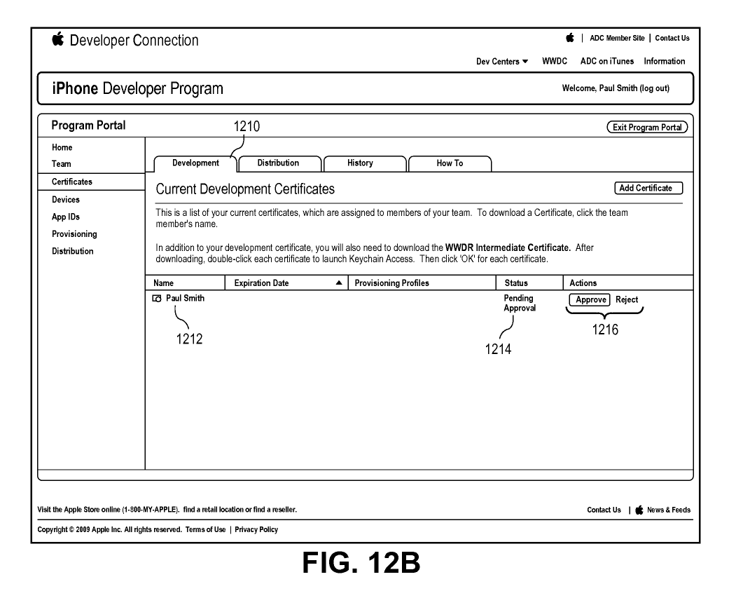

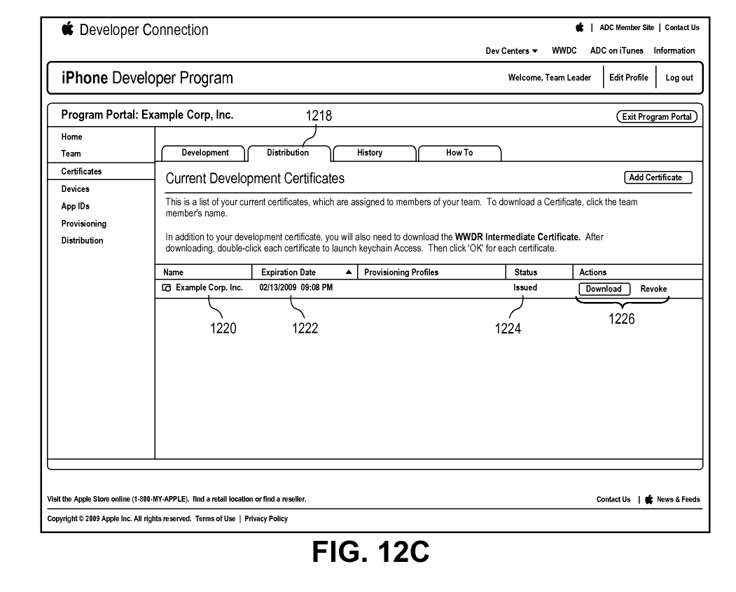

FIG. 1B is a flow diagram illustrating a method for providing an application for distribution by a portal. At block 112, the portal generates an application signing certificate in response to a user request. For example, a user may request a development certificate, which may be used to sign the application for a development distribution. A development distribution may be used for debugging purposes. Generation of application signing certificates is described in greater detail below in conjunction with FIGS. 5 and 12A-12C. In one embodiment, the user requesting the application signing certificate is not authorized to approve the request. In this embodiment, a team agent or team leader is notified of the request and may approve the request, at which point processing can continue to block 114.

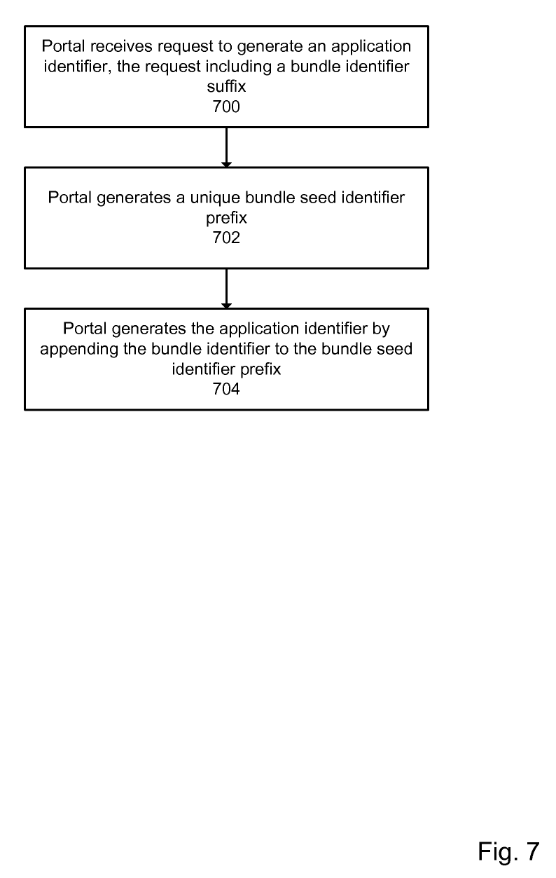

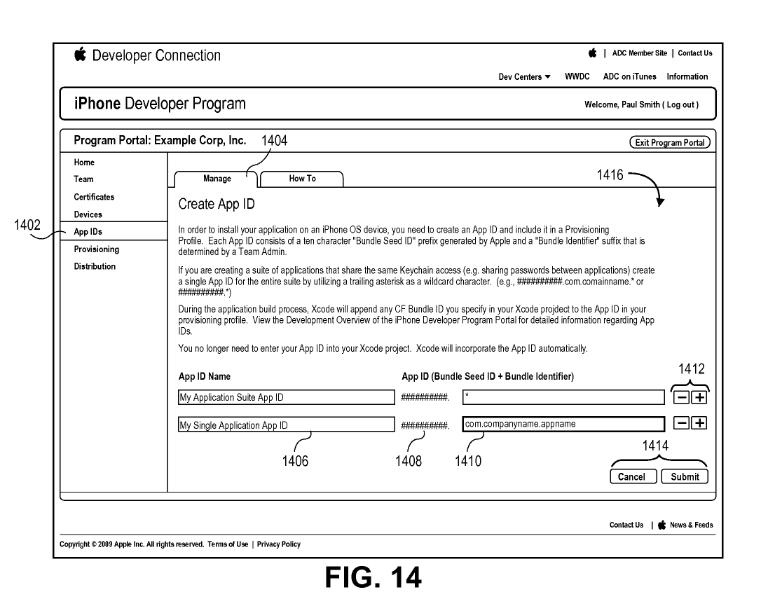

At block 114, the portal generates an application identifier in response to a user request. An application identifier uniquely identifies an application being developed using the portal. In one embodiment, the application identifier may allow sharing of data between applications. The application identifier may also allow an application to communicate with supported services not included in the application itself (e.g., accessories). Generation of application identifiers is described in greater detail below in conjunction with FIGS. 7 and 14.

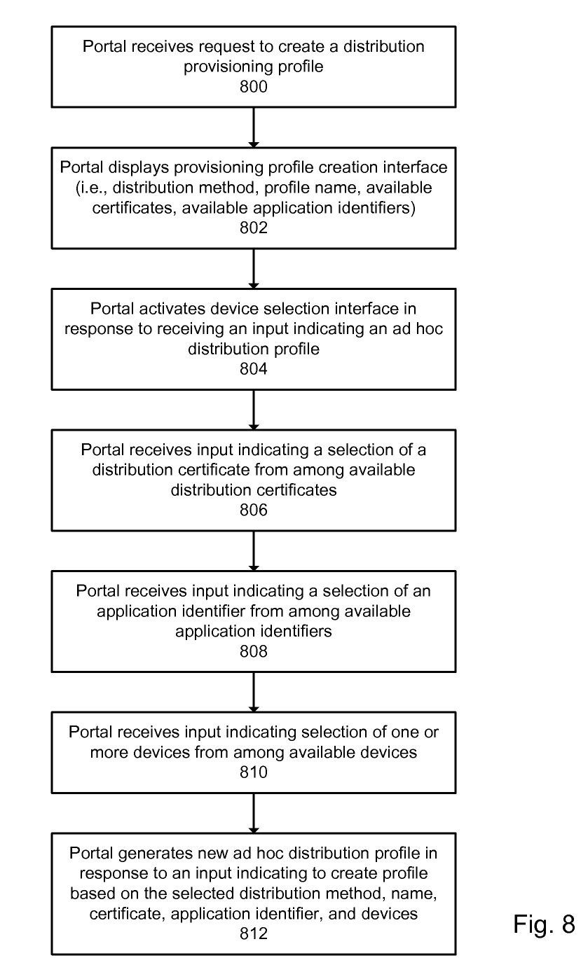

At block 116, the portal generates a provisioning profile in response to a user request. The profile includes the certificate generated at block 112 and the application identifier generated at block 114. Generation of provisioning profiles is described in greater detail below in conjunction with FIGS. 8, 15, 16, and 17. In one embodiment, the provisioning profile is signed by a trusted certificate. In this embodiment, a device will only allow installation of an application if the provisioning profile is signed by a trusted certificate.

At block 118, the provisioning profile is made available for distribution to devices. In one embodiment, an application developed with the assistance of the portal cannot be executed on a device (e.g., a smartphone such as the iPhone by Apple Inc.) unless a valid provisioning profile accompanies the application.

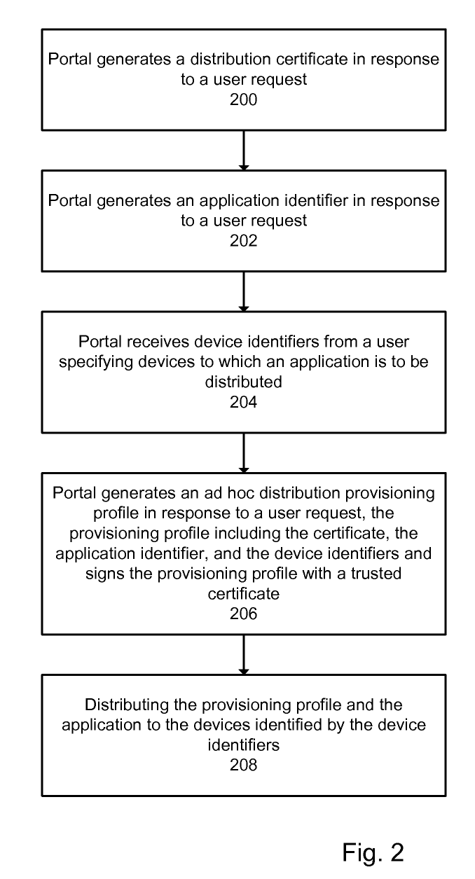

Developers of applications may distribute an application developed with the assistance of the portal in different ways. FIG. 2 illustrates one embodiment of an ad hoc distribution, in which the developer uses the portal to specify the devices upon which the application may run. In one embodiment, an organization providing access to the portal may restrict the number of devices available to the developer. For example, an ad hoc distribution may be limited to one hundred devices.

At block 200, the portal generates a distribution certificate in response to a user request. The distribution certificate is used to sign the application in order to allow a device to authenticate it.

At block 202, the portal generates an application identifier in response to a user request. The application identifier uniquely identifies the application currently being developed with the assistance of the portal.

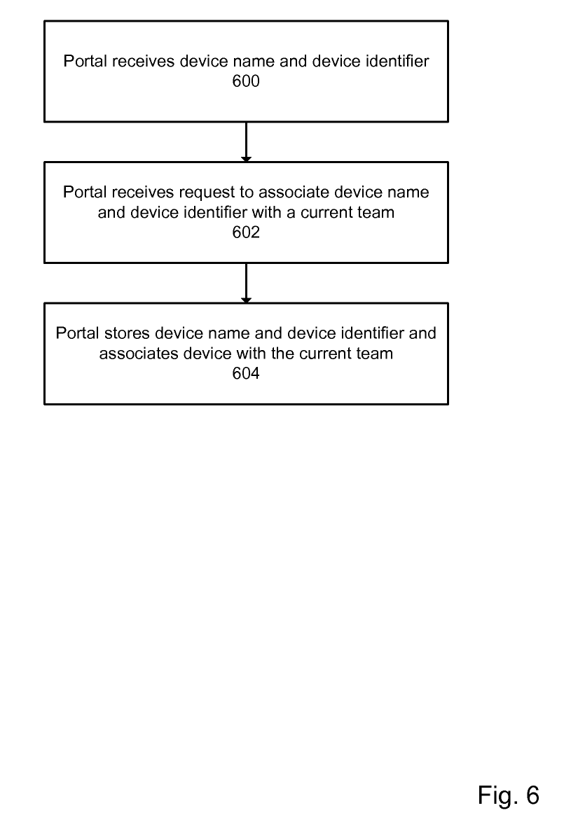

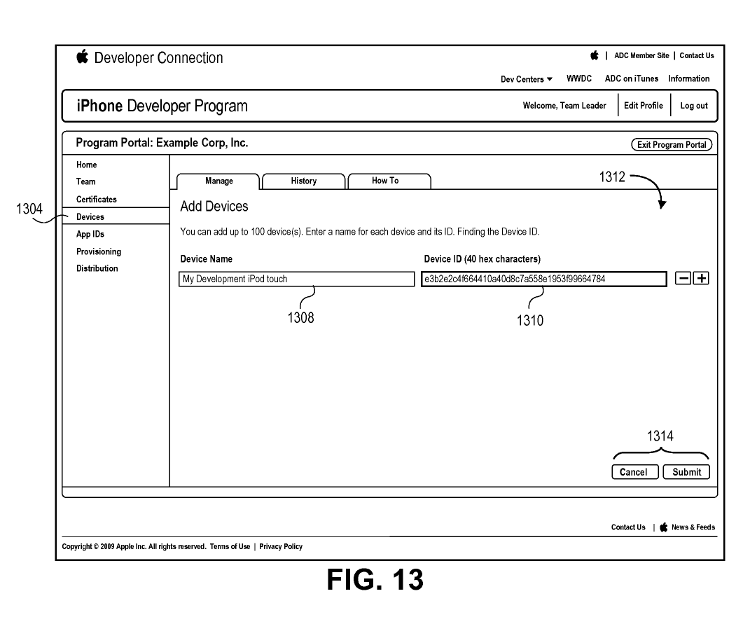

At block 204, the portal receives a list of device identifiers from a user. The list identifies the devices that are targeted by the current ad hoc distribution. In one embodiment, the device identifiers are entered by a user using the portal. In another embodiment, a file containing the list of identifiers is uploaded to the portal. Device identifiers are described in greater detail below in conjunction with FIGS. 6 and 13.

At block 206, the portal generates an ad hoc distribution provisioning profile in response to a user request. The provisioning profile includes the certificate, the application identifier, and the list of device identifiers. In one embodiment, the provisioning profile is signed by a trusted certificate. In this embodiment, a device will only allow installation of an application if the provisioning profile is signed by a trusted certificate.

At block 208, the provisioning profile and the application are provided for distribution to the devices identified by the list of device identifiers. In one embodiment, only devices identified by the list of identifiers in the provisioning profile can operate the application.

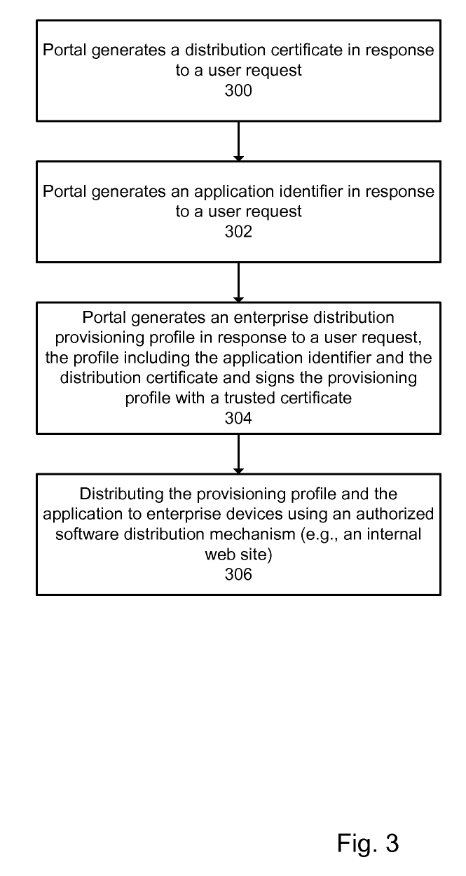

Some organizations or enterprises possess a data infrastructure capable of internally distributing applications to devices. For example, a corporation may possess an internal network upon which applications and provisioning profiles may be made available. Devices belonging to the corporation may connect to the internal network and download the application and provisioning profile. FIG. 3 illustrates a method of enterprise distribution.

At block 300, the portal generates a distribution certificate in response to a user request. At block 302, the portal generates an application identifier in response to a user request. At block 304, the portal generates an enterprise distribution provisioning profile in response to a user request. The provisioning profile includes the distribution certificate and the application identifier.

At block 306, the application and distribution certificate are provided for distribution to enterprise devices using an authorized software distribution mechanism, such as an internal website. The enterprise distribution model provides enhanced flexibility for distribution of the application and provisioning profile, since device eligibility depends upon the device's ability to authenticate itself to the authorized distribution mechanism, rather than appearing in the list of devices included in an ad hoc distribution provisioning profile.

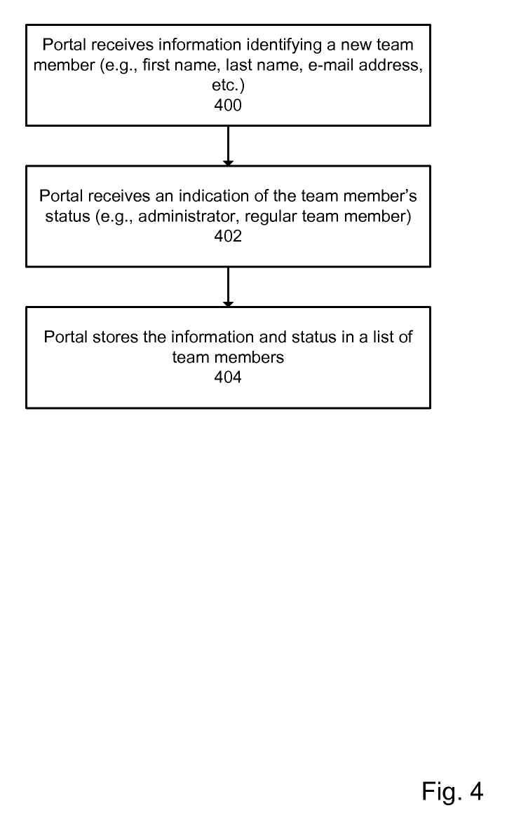

In one embodiment, before a user can issue a request to the portal, the user must be authenticated (e.g., log on to the portal in a way to verify the user's identity, such as providing a user name and password). Before a user can log on, the user must be associated with the current team. A user associated with a team may be referred to as a team member of that team. FIG. 4 illustrates a method by which the portal may associate a user with the current team. At block 400, the portal receives information identifying a new team member. For example, the information may include first name, last name, an e-mail address, etc. In one embodiment, an existing user inputs the new user's information into the portal. The existing user may be a team agent, whose account may be created outside the portal context by a representative of the organization providing the portal.

At block 402, the portal receives an indication of the new team member's status. For example, a new team member may be granted administrator status. In one embodiment, an administrator is capable of authorizing application signing certificate requests, as described below in conjunction with FIG. 5. A new user may also be assigned the status of “team member” which may enable the new user to request certificates, download authorized certificates, etc. At block 404, the method stores the new user information and status in a list of team members, which allows the user to be authenticated.

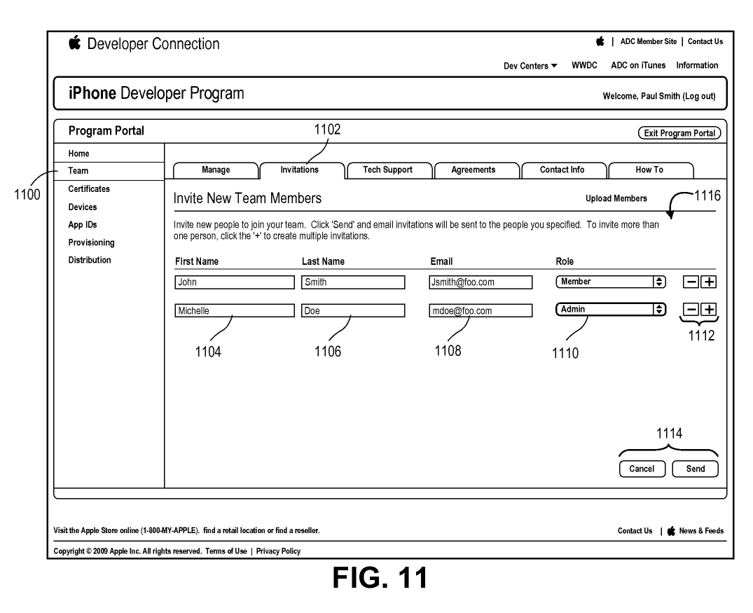

FIG. 11 shows one embodiment of a portal interface which may be used in conjunction with the method illustrated in FIG. 4. Highlighted region 1100 and selected tab 1102 indicate that the display area 1116 corresponds to inviting new team members. Text field 1104 allows input of a new user's first name. Text field 1106 allows input of a new user's last name. Text field 1108 allows input of a new user's e-mail address. Combo box 1110 allows specification of the new user's status. Buttons 1112 may be used to add another new user (“+”) or to remove the entry for the current new user (“−”). Actions 1114 allow sending invitations to the new users or canceling the current task of entering new users. In one embodiment, team members can be added by uploading a list of names and email addresses of the members to be added.

In one embodiment, the portal uses an application signing certificate to enable a device to authenticate an application and provisioning profile. FIG. 5 illustrates a method by which the portal may generate an application signing certificate. At block 500, the portal receives a certificate request from a user. The request may include a public key from a previously generated key pair, or the portal may generate the key pair. The key pair may be a public/private key pair as is known in the art.

At block 502, the portal verifies that the certificate signing request meets certain criteria. For example, the portal may require that the key size be at least 2048 bits, and the portal may reject the certificate request if the key size does not meet the criteria.

At block 504, the method generates a notification of the request. In one embodiment, the request received by the portal at block 500 originated from a user who is not authorized to generate certificates under their own authority. For example, a team member who isn't a team agent or a team administrator may not be authorized to generate certificates.

At block 506, the portal receives an authorization of the certificate request. For example, a team administrator may review the notification generated by the portal at block 504 and authorize the request. In one embodiment, the authorization is required before the certificate request is submitted to the entity who will sign the certificate.

At block 508, the portal generates a notification indicating that the certificate request has been authorized. In one embodiment, this notification is used to alert the team member who originated the request for a certificate that the request has been authorized.

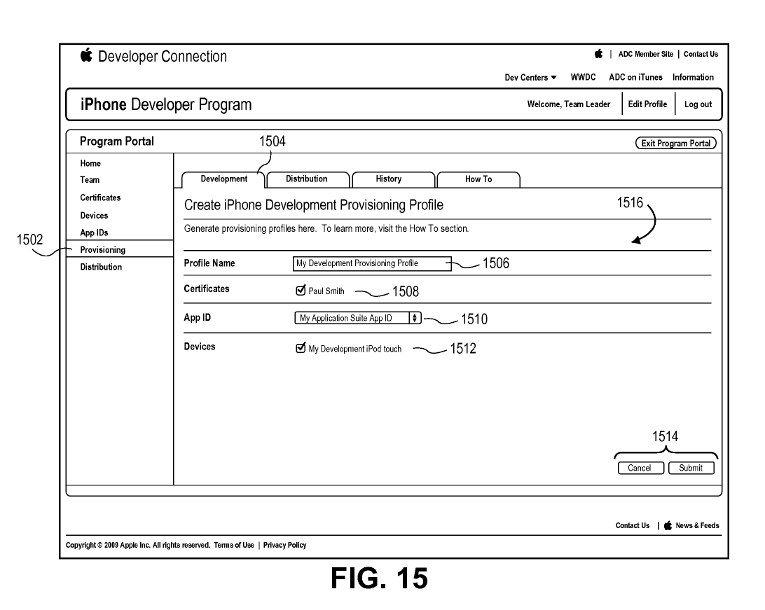

At block 510, the portal generates the requested application signing certificate using the public key provided with the request at block 500. A key pair may be generated using a software application, such as the Keychain Access application included with the Mac OS X Leopard operating system by Apple Inc. In one embodiment, the public key is replaced by the application signing certificate. In one embodiment, the certificate request is uploaded to the portal and a third party proprietary certificate generation technology is used to create the signing certificate. In another embodiment, the signing certificate is unique to the organization providing the portal. In still another embodiment, the application signing certificate includes a unique extension marker signifying that it is used for signing applications for a device, such as an iPhone by Apple Inc. An application store such as the store provided by Apple iTunes may not accept any application without a certificate containing the unique extension marker. In still another embodiment, the replaced public key (e.g., the application signing certificate) is included in a provisioning profile used to install applications on devices. Provisioning profiles are described in greater detail below in conjunction with FIGS. 8 and 15. In one embodiment, a device that receives the provisioning profile and the application determines if the provisioning profile has been signed by a trusted certificate (e.g., by the organization providing the profile) and/or determines if the application identifier of the application matches the application identifier included in the provisioning profile, and the device only allows installation and execution of the application if one or more of the conditions are satisfied.

At block 512, the portal makes the certificate available. In one embodiment, the certificate may be downloaded by the user who requested it, a team agent, and a team administrator.

FIG. 12A illustrates a portal interface that may be used in conjunction with the method illustrated in FIG. 5. Highlighted area 1202 and selected tab 1204 indicate that display area 1210 corresponds to creating distribution certificates. Button 1206 allows a user to open a file dialog window that can be used to select a certificate request file. Button 1208 causes the file to be uploaded to the portal.

FIG. 12B illustrates a portal interface for development certificates, as indicated by selected tag 1210. Name 1212 indicates the originator of the request for the certificate. Status 1214 indicates that the request is still pending an awaiting approval. Actions 1216 indicate the actions available to the current portal user. The “approve” button will approve the request, while the “reject” button will reject it. In one embodiment, the “approve” and “reject” buttons are only available to team agents and team administrators. The buttons may be grayed out or not displayed if the actions corresponding to the buttons are not available to the current user. A similar interface to the interface illustrated in FIG. 12B may be used for distribution certificates.

FIG. 12C illustrates another portal interface for distribution certificates as indicated by selected tab 1218. Name 1220 identifies the originator of the distribution certificate request. Expiration date 1222 indicates when the certificate will expire. Status 1224 indicates that the certificate has been issued. Actions 1226 indicate that the current user is authorized to download the certificate or to revoke it. In one embodiment, if the current user lacks authorization for an action, the corresponding interface item may be grayed out or not displayed.

The embodiment of ad hoc distribution described above in conjunction with FIG. 2 uses a device list to specify in the provisioning profile which devices are eligible to operate the corresponding application. FIG. 6 illustrates a method by which the portal associates a device with the current team.

At block 600, the portal receives a device name and a unique device identifier. In one embodiment, the portal receives the name and identifier from a user. In one embodiment, device names and identifiers are input using a graphical user interface associated with the portal, such as a web page. In another embodiment, a list of device identifiers and device names may be uploaded to the portal. In one embodiment, a device identifier is an alphanumeric string uniquely identifying the corresponding device.

At block 602, the portal receives a request to associate the device name and the device identifier with the current team. At block 604, the portal stores the device name and the device identifier in a list of devices, which associates the device with the current team.

FIG. 13 illustrates a portal interface that may be used in conjunction with the method illustrated in FIG. 6. Highlighted area 1304 indicates that display area 1312 is associated with adding devices to the team. Device name 1308 and device ID 1310 allow a user to input a human-readable name and a unique device identifier, respectively. Actions 1314 indicate that the user may submit the input device information for association with the current team or cancel device addition.

The embodiment of application distribution described above in conjunction with FIG. 1 uses an application identifier to uniquely identify an application being developed by the current team. FIG. 7 illustrates a method by which the portal may generate an application identifier.

At block 700, the portal receives a request to generate an application identifier. The request may include a bundle identifier suffix. In one embodiment, a bundle identifier suffix is created by a team member to identify the application. Although any style may be used, one style is a reverse-domain name style, such as, “com.apple.AddressBook.” In one embodiment, the current team may be developing a suite of applications.

If the suite of applications has the same security requirements (i.e., sharing passwords between applications) or no security requirements (i.e., no passwords) then a special-case application identifier may be used for each application in the suite. In one embodiment, the bundle identifier suffix of the special-case application identifier ends with a trailing asterisk. For example, “com.apple.ApplicationSuite.*” which may include several applications. Alternatively, if the special-case criteria are not met (e.g., applications in the suite don't have the same security requirements) more than one application identifier may be used.

At block 702, the portal generates a unique bundle seed identifier prefix. In one embodiment, the bundle seed identifier prefix is a universally unique 10 character identifier generated by the organization providing the portal.

At block 704, the portal generates the application identifier by appending the bundle identifier to the bundle seed identifier prefix. In one embodiment, only team agents and team administrators are authorized to request the generation of an application identifier. In one embodiment, a provisioning profile without an application identifier is insufficient to allow operation of an application on a device.

FIG. 14 illustrates a portal interface that may be used in conjunction with the method illustrated in FIG. 7. Highlighted area 1402 and selected tab 1404 indicate that display region 1416 corresponds to the creation of application identifiers. Field 1406 allows input of a name for the application identifier. In one embodiment, this name is not used to uniquely identify the application but rather provides a convenient reference to the application identifier within the context of the team. Text 1408 offers a reminder that the unique bundle seed identifier will precede the user specified bundle identifier in field 1410. Buttons 1412 allow additional application identifiers to be created (“+”) or to remove the bottom-most application identifier (“−”). Actions 1414 allow the current user to submit the application identifier or to cancel the application identifier input operation.

The embodiment of the ad hoc distribution model described above in conjunction with FIG. 2 uses a provisioning profile to assemble various components needed to successfully distribute an application to a device. FIG. 8 illustrates a method by which the portal may generate an ad hoc distribution provisioning profile.

At block 800, the portal receives a request to create a distribution provisioning profile. In one embodiment, a distribution provisioning profile requires a certificate from a certificate authority in order to allow a device to authenticate the application. In another embodiment, a distribution provisioning profile may only be created by the team agent.

At block 802, the portal displays a provisioning profile creation interface. One example of a provision profile creation interface is illustrated in FIG. 15, which is described below.

At block 804, the portal activates a device selection interface in response to receiving an input indicating that the distribution model is an ad hoc distribution model. In one embodiment, the provisioning profile creation interface may support multiple distribution models. For example, distribution by way of an application store does not use a list of devices, whereas an ad hoc distribution uses a list of devices. The device selection interface may be disabled if the selected distribution model is not ad hoc.

At block 806, the portal receives input indicating a selection of a distribution certificate from among available distribution certificates. In one embodiment, each team uses only one distribution certificate. In one embodiment, the portal is able to provide a listing of all or some of the distribution certificates associated with the current team. For example, the portal may only list certificates that have issued.

At block 808, the portal receives input indicating a selection of an application identifier from among available identifiers. In one embodiment, the provisioning profile creation interface may display application identifiers and accept a selection using a combo box.

At block 810, the portal receives an input indicating selection of one or more devices from among available devices. In one embodiment, each device associated with the team is displayed with an adjacent check box interface item. In another embodiment, an additional interface item is displayed which allows a user to select all of the devices associated with the team.

At block 812, the portal generates an ad hoc distribution profile in response to an input indicating to create the profile. The profile includes the selected certificate, the selected list of devices, a name, and the selected application identifier. In one embodiment, provisioning profiles are assigned expiration dates by the organization providing the portal or due to expiration of the certificates associated with the profile. In another embodiment, the portal may indicate that a profile has expired and may allow a user to renew the profile. A user may also download the provisioning profile from the portal, for example to distribute the profile and the application to the devices listed in an ad hoc provisioning profile.

In some embodiments, while the application is being developed, a team member may find it beneficial to install the application on devices belonging to the team for testing purposes only. A development installation may be similar to an ad hoc distribution, as both may utilize a list of devices eligible to operate the application. A development installation may differ from an ad hoc distribution by using one or more certificates issued by a certificate authority containing a different unique extension marker and allowing for the debugging of the application, since the list of targeted devices will be small (e.g., team members).

FIG. 15 illustrates a portal interface that may be used by a team member to generate a development provisioning profile. Highlighted region 1502 and selected tab 1504 indicate that display region 1516 corresponds to creating development provisioning profiles. Profile name 1506 allows the user to input a name for the profile for easy reference. Certificate 1508 allows the user to select a development certificate for the profile. Application identifier 1510 allows the user to select the application identifier corresponding to the application the user wishes to distribute. Devices 1512 allows the user to select one or more devices eligible to operate the application. Actions 1514 allow the user to submit the request for a development provisioning profile and cancel allows the user to forego submitting the request. In one embodiment, any authorized user associated with the team may submit a request for a development provisioning profile. In another embodiment, only a team agent or team administrator may authorize a request for a development provisioning profile.

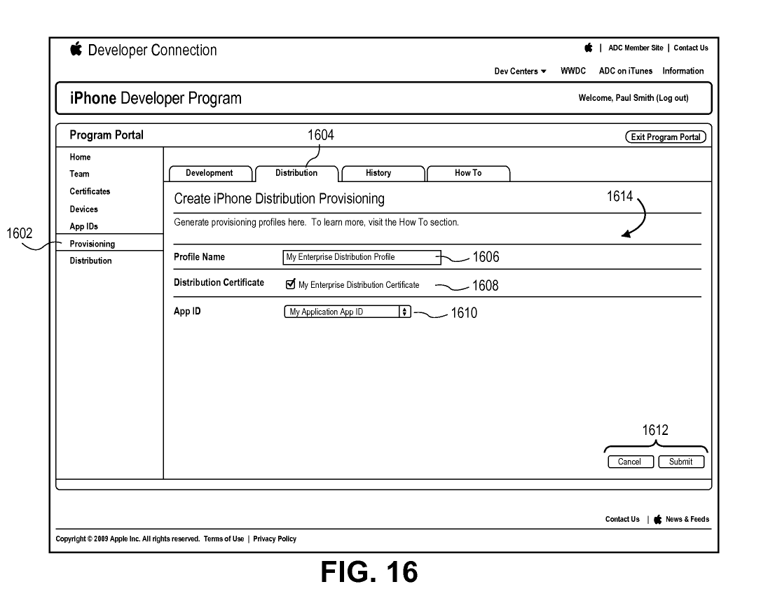

FIG. 16 illustrates a portal interface that may be used in conjunction with the method of enterprise distribution illustrated in FIG. 3. Highlighted region 1602 and selected tab 1604 indicate that display region 1614 corresponds to creating distribution provisioning profiles. Name 1606 allows a user to input a name for the profile. Certificate 1608 allows the user to select an enterprise distribution certificate for the enterprise distribution provisioning profile. Application identifier 1610 allows the user to select the application identifier of the application to be distributed using the enterprise distribution provisioning profile. Actions 1612 allow the user to submit the request for the enterprise distribution provisioning profile or to cancel. In one embodiment, only a team administrator or team agent may request an enterprise distribution provisioning profile and only a team agent may authorize it. In an alternative embodiment, any user may request the distribution profile. In yet another alternative embodiment, the team agent may specify, based on the type of profile, what types of users may request and authorize requests.

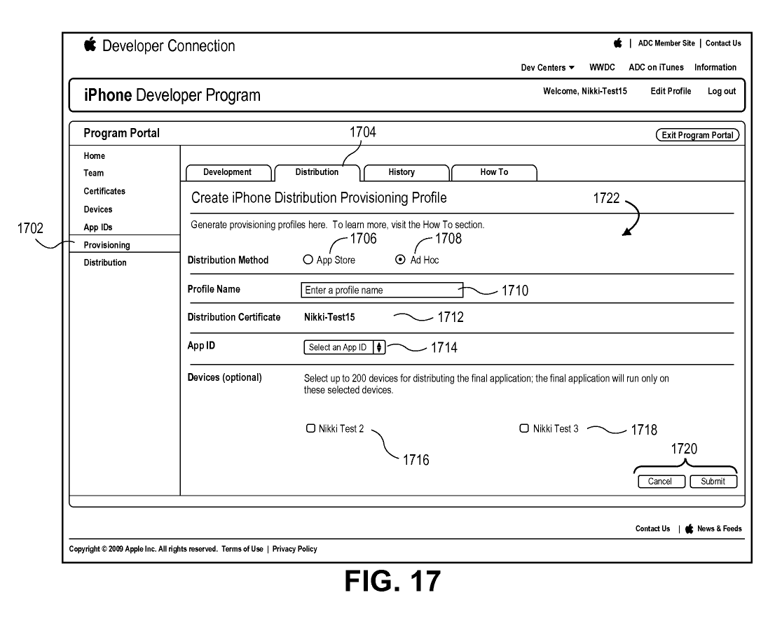

FIG. 17 illustrates a portal interface that may be used in conjunction with the method of ad hoc distribution illustrated in FIG. 2. Highlighted area 1702 and selected tab 1704 indicate that display region 1722 corresponds to creating distribution provisioning profiles. Radio button 1706 allows the user to select that an application should be distributed commercially. In one embodiment, commercial distribution requires submission of the application and corresponding distribution provisioning file to an organization (e.g., the organization providing the portal, another organization providing an application store, etc.) for review according to an application store (e.g., iTunes App Store) standards.

Radio button 1708 allows the user to specify an ad hoc distribution provisioning profile. In one embodiment, selecting radio button 1708 causes the portal to activate radio buttons 1716 and 1718, indicating to the user that the ad hoc profile may require the user to specify the devices that will be eligible to operate the application. Name 1710 allows the user to specify a name for the profile. Certificate 1712 allows the user to specify a distribution certificate for the profile. Combo box 1714 allows the user to specify an application identifier for the provisioning profile that corresponds to the application to be distributed with the provisioning profile.

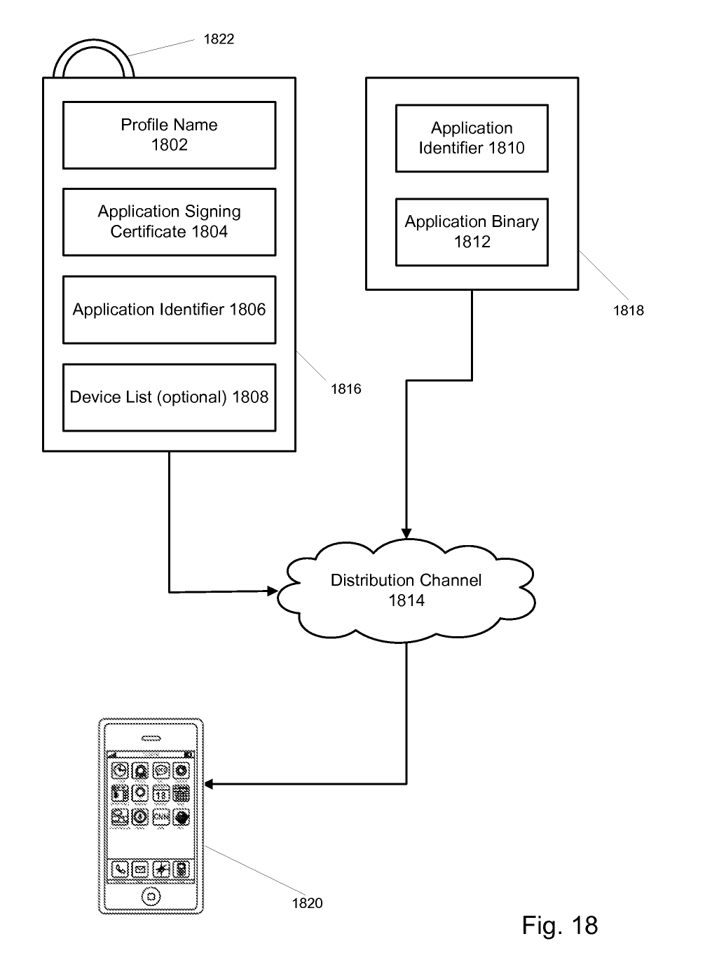

FIG. 18 is a diagram illustrating the data flow of application distribution according to an embodiment of the invention. Provisioning profile 1816 includes name 1802, certificate 1804, application identifier 1806, and optionally device list 1808. Provisioning profile 1816 may have been generated using the methods described above. Application 1818 includes application identifier 1810 and application binary 1812. Application 1818 may have been built on a development machine by team members of the current team. Application binary 1812 includes executable computer instructions used to operate the application 1818. Application identifier 1810 and application identifier 1806 are a match, indicating that the provisioning profile 1816 is intended to provision the application 1818 on devices such as device 1820. Lock symbol 1822 indicates that provisioning profile 1816 has been signed by a trusted certificate. In one embodiment, device 1820 verifies that provisioning profile 1816 has been signed by a trusted certificate before allowing installation of application 1818. The trusted certificate may originate with or be used by the organization providing the portal.

Provisioning profile 1816 and application 1818 are distributed to device 1820 through distribution channel 1814. Distribution channel 1814 may be an internal enterprise server as in the enterprise distribution model. Distribution channel 1814 may be an e-mail or other electronic data transfer. For example, in the ad hoc distribution model, the channel may take whatever form is easiest for the distributors or device owners, since the device identifier of device 1820 (not shown) is able to operate application 1818 because device 1820 is identified in device list 1808. Distribution channel 1814 may also take the form of an application store, such as an application store available through iTunes by Apple Inc. The application store interface (such as the iTunes application) may run on a desktop computer (e.g., data processing system 900) and download application 1818 and profile 1816. The downloaded data may then be transferred to another data processing device, such as device 1820. In another embodiment, the application store interface may run on the device 1820 and download application 1818 and profile 1816 directly to the device 1820.

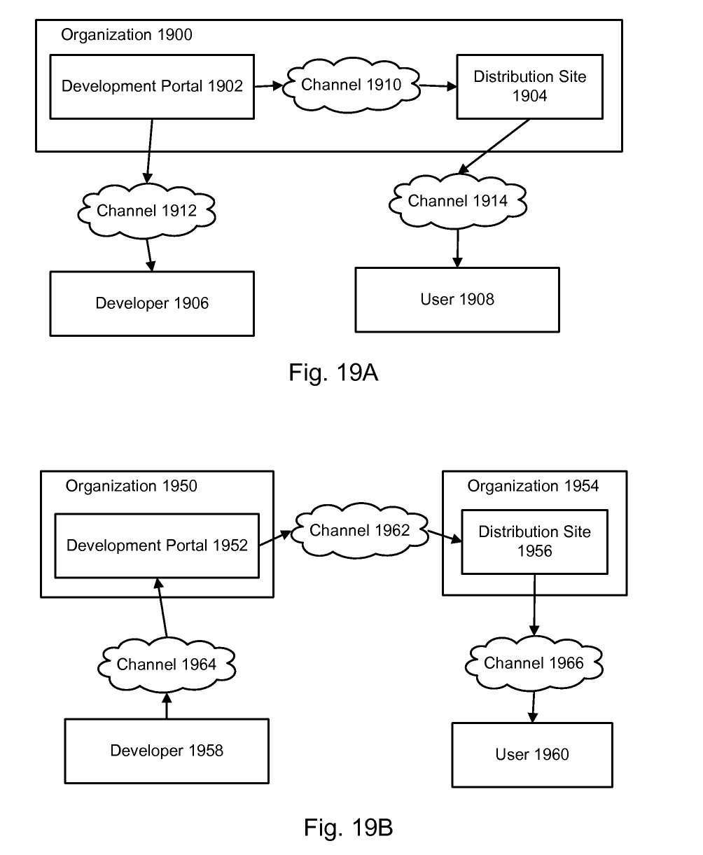

FIG. 19A illustrates one embodiment of the invention in which an organization 1900 includes development portal 1902 and distribution site 1904. For example, organization 1900 may be Apple Inc., the developer portal 1902 may be the portal illustrated in FIG. 1A, and the distribution site 1904 may be the application store provided by Apple iTunes. Channel 1910 provides a link between development portal 1902 and distribution site 1904, and may be implemented as an internal network, a secured connection over a public network, etc. Channel 1912 provides a developer 1906 with access to development portal 1902. Channel 1912 may also be an internal network or a secure connection over a public network. User 1908 may acquire an application for his or her device from distribution site 1904 through channel 1914, such as a cable modem, a cellular network link, etc.

FIG. 19B illustrates an alternative embodiment, in which an organization 1950 provides development portal 1952 while an organization 19054 provides distribution site 1956. For example, development portal 1952 may be the portal illustrated in FIG. 1A and organization 1950 may be Apple Inc. Distribution site 1956 may be an internal website of a large enterprise organization 1954, which creates applications with the assistance of development portal 1952 and distributes applications through its own distribution site 1956. An enterprise user of organization 1954 may acquire an application for a device through channel 1966 from distribution site 1956. Channel 1966 may be an internal network. Developer 1958, which in one embodiment may be an employee of organization 1954 or a third party, accesses development portal 1952 through channel 1964, which may be a secure connection over a public network. In another embodiment, organization 1954 is an educational organization such as a university, developer 1958 may be a student or professor associated with the educational organization, and a similar secure connection may be used.

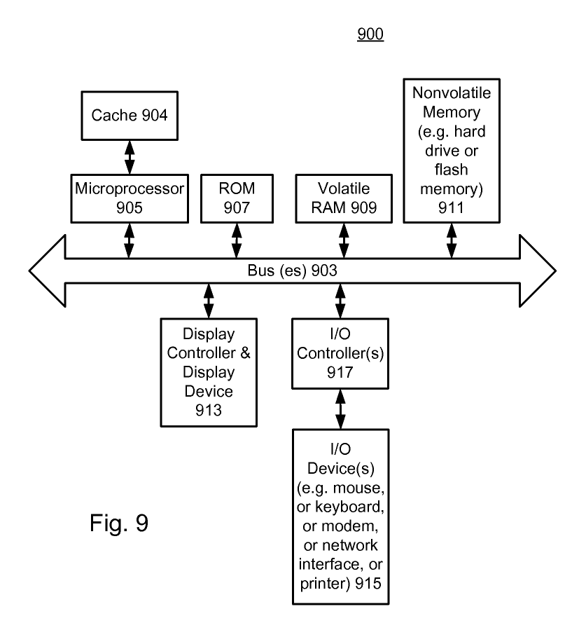

FIG. 9 shows one example of a data processing system that may be used with one embodiment the present invention. Note that while FIG. 9 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 9, the computer system 900, which is a form of a data processing system, includes a bus 903 which is coupled to a microprocessor(s) 905 and a ROM (Read Only Memory) 907 and volatile RAM 909 and a non-volatile memory 911. The microprocessor 905 is coupled to cache 904. The microprocessor 905 may retrieve the instructions from the memories 907, 909, 911 and execute the instructions to perform operations described above. The bus 903 interconnects these various components together and also interconnects these components 905, 907, 909, and 911 to a display controller and display device 913 and to peripheral devices such as input/output (I/O) devices which may be mice, keyboards, modems, network interfaces, printers and other devices which are well known in the art. Typically, the input/output devices 915 are coupled to the system through input/output controllers 917. The volatile RAM (Random Access Memory) 909 a machine readable storage medium and is typically implemented as dynamic RAM (DRAM) which requires power continually in order to refresh or maintain the data in the memory. A machine readable storage medium may store executable instructions which when executed by a processor cause the processor to perform a method.

The mass storage 911 is another machine readable storage medium and is typically a magnetic hard drive or a magnetic optical drive or an optical drive or a DVD RAM or a flash memory or other types of memory systems which maintain data (e.g. large amounts of data) even after power is removed from the system. Typically, the mass storage 911 will also be a random access memory although this is not required. While FIG. 9 shows that the mass storage 911 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

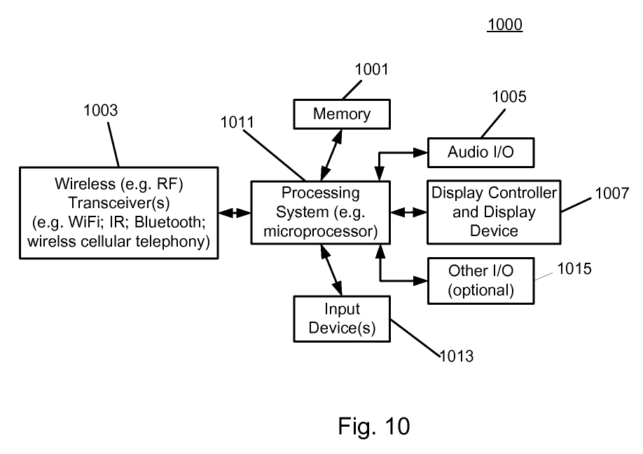

FIG. 10 shows an example of another data processing system which may be used with one embodiment of the present invention. For example, system 1000 may operate an application provided for distribution with the assistance of the portal. The data processing system 1000 shown in FIG. 10 includes a processing system 1011, which may be one or more microprocessors, or which may be a system on a chip integrated circuit, and the system also includes memory 1001 for storing data and programs for execution by the processing system. The system 1000 also includes an audio input/output subsystem 1005 which may include a microphone and a speaker for, for example, playing back music or providing telephone functionality through the speaker and microphone.

A display controller and display device 1007 provide a visual user interface for the user; this digital interface may include a graphical user interface which is similar to that shown on a Mac computer when running OS X operating system software. The system 1000 also includes one or more wireless transceivers 1003 to communicate with another data processing system, such as the system 900 of FIG. 9. A wireless transceiver may be a WiFi transceiver, an infrared transceiver, a Bluetooth transceiver, and/or a wireless cellular telephony transceiver. It will be appreciated that additional components, not shown, may also be part of the system 1000 in certain embodiments, and in certain embodiments fewer components than shown in FIG. 10 may also be used in a data processing system.

The data processing system 1000 also includes one or more input devices 1013 which are provided to allow a user to provide input to the system. These input devices may be a keypad or a keyboard or a touch panel or a multi touch panel. The data processing system 1000 also includes an optional input/output device 1015 which may be a connector for a dock. It will be appreciated that one or more buses, not shown, may be used to interconnect the various components as is well known in the art. The data processing system shown in FIG. 10 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device. In other embodiments, the data processing system 1000 may be a network computer or an embedded processing device within another device, or other types of data processing systems which have fewer components or perhaps more components than that shown in FIG. 10.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method for developing an application for a data processing device using a portal, the method comprising:
generating, using the portal, an application signing certificate;
designating, using the portal, the data processing device using a unique device identifier;
creating, using the portal, a unique application identifier for the application; and
creating, using the portal, an application provisioning profile, wherein the application provisioning profile comprises the application signing certificate, the unique application identifier, and the unique device identifier.

2. The method of claim 1, further comprising:
signing the application provisioning profile with a trusted certificate;
providing the application and the application provisioning profile for distribution to the data processing device, wherein executing the application on the data processing device requires the application provisioning profile and wherein the application provisioning profile allows the application to be executed on the data processing device.

3. The method of claim 1 wherein the application provisioning profile is an ad hoc distribution profile.

4. The method of claim 1, wherein the portal comprises a world wide web interface executing on a data processing system.

5. The method of claim 1, wherein generating the application signing certificate comprises:
receiving a request for the application signing certificate; and
authorizing, using the portal, the application signing certificate.

6. The method of claim 5, wherein the requesting is performed by a first user and the authorizing is performed by a second user and wherein the first user is unable to authorize the application signing certificate.

7. A machine implemented method for developing an application for a data processing device, the method comprising:
requesting an application signing certificate;
inputting a unique device identifier identifying the data processing device;
requesting a unique application identifier for the application;
requesting an application provisioning profile, wherein the application provisioning profile comprises the requested application signing certificate, the requested unique application identifier, and the inputted unique device identifier.

8. The method of claim 7, further comprising:
inputting authentication data comprising a user name and a password.

9. The method of claim 7, wherein the unique application identifier comprises a first portion provided with the request and a second portion, wherein the second portion is unique.

10. The method of claim 7, wherein the requesting the application, the inputting the unique device identifier, the requesting the unique application identifier, and the requesting the application provisioning profile are performed using a single portal accessed by a data processing system.

11. The method of claim 10, wherein the single portal is a world wide web interface and wherein the single portal is provided by an organization.

12. A machine readable storage medium storing executable instructions which when executed by a processor cause the processor to perform a method for developing an application for a data processing device using a portal, the method comprising:
generating, using the portal, an application signing certificate;
designating, using the portal, the data processing device using a unique device identifier;
creating, using the portal, a unique application identifier for the application; and
creating, using the portal, an application provisioning profile, wherein the application provisioning profile comprises the application signing certificate, the unique application identifier, and the unique device identifier.

13. The machine readable storage medium of claim 12, wherein the method further comprises:
signing the application provisioning profile with a trusted certificate;
providing the application and the application provisioning profile for distribution to the data processing device, wherein executing the application on the data processing device requires the application provisioning profile and wherein the application provisioning profile allows the application to be executed on the data processing device.

14. The machine readable storage medium of claim 12 wherein the application provisioning profile is an ad hoc distribution profile.

15. The machine readable storage medium of claim 12, wherein the portal comprises a world wide web interface.

16. The machine readable storage medium of claim 12, wherein generating the application signing certificate comprises:
receiving a request for the application signing certificate; and
authorizing, using the portal, the application signing certificate.

17. The machine readable storage medium of claim 16, wherein the requesting is performed by a first user and the authorizing is performed by a second user and wherein the first user is unable to authorize the application signing certificate.

18. A machine readable storage medium storing executable instructions which when executed by a processor cause the processor to perform a method for developing an application for a data processing device using a portal, the method comprising:
requesting an application signing certificate;
inputting a unique device identifier identifying the data processing device;
requesting a unique application identifier for the application;
requesting an application provisioning profile, wherein the application provisioning profile comprises the requested application signing certificate, the requested unique application identifier, and the inputted unique device identifier.

19. The machine readable storage medium of claim 18, the method further comprising:
inputting authentication data comprising a user name and a password.

20. The machine readable storage medium of claim 18, wherein the unique application identifier comprises a first portion provided with the request and a second portion, wherein the second portion is unique.

21. The machine readable storage medium of claim 18, wherein the requesting the application, the inputting the unique device identifier, the requesting the unique application identifier, and the requesting the application provisioning profile are performed using a single portal.

22. The machine readable storage medium of claim 21, wherein the single portal is a world wide web interface and wherein the single portal is provided by an organization.

23. A data processing system comprising:
means for generating, using a portal executing on a hardware device, an application signing certificate;
means for designating, using the portal, a data processing device using a unique device identifier;
means for creating, using the portal, a unique application identifier for an application;
means for creating, using the portal, an application provisioning profile, wherein the application provisioning profile comprises the application signing certificate, the unique application identifier, and the unique device identifier; and
means for signing, using the portal, the application provisioning profile with a trusted certificate.

24. A data processing system comprising:
means for requesting, using a hardware device, an application signing certificate;
means for inputting a unique device identifier identifying a data processing device;
means for requesting a unique application identifier for an application;
means for requesting an application provisioning profile, wherein the application provisioning profile comprises the requested application signing certificate, the requested unique application identifier, and the inputted unique device identifier.
